(19) United States
(12) Patent Application Publication
(10) Pub. No.: US 2010/0011065 A1
(43) Pub. Date: Jan. 14, 2010

(54) INSTANT MESSAGING CONTENT STAGING

(76) Inventors: Josef A. Scherpa, Fort Collins, CO (US); Andrew L. Schirmer, Andover, MA (US)

Correspondence Address: HOFFMAN WARNICK LLC, 75 STATE STREET, 14TH FLOOR, ALBANY, NY, 12207, US

(21) Appl. No.: 12/169,586

(22) Filed: Jul. 8, 2008

(51) Int. Cl. G06F 15/16

(52) U.S. Cl. 709/206

(57) ABSTRACT

The invention provides a method, system, and program product for staging content for an instant messaging (IM) chat session. In one embodiment, the invention includes entering content into a staging area and transferring the entered content from the staging area to an input area.

### FIELD OF THE INVENTION

The invention relates generally to instant messaging (IM) and, more particularly, to a method, system, and program product for the staging of content for use in an IM chat session.

### BACKGROUND OF THE INVENTION

Instant messaging (IM) has become a popular and valuable communication tool. One inefficiency of IM, however, arises when a first participant to a chat session begins to add content to an input area of an IM chat window, only to receive a message from a second participant that changes the necessity, context, appropriateness, or relevance of the content entered by the first participant. If, for example, the first participant still wants to add the content to the chat session, but wants to do so at a later time in order to respond to the second participant's most recent message, he/she will generally select and cut the content from the input area and replace it with other content. This runs the risk, however, that the first participant will either forget to subsequently paste the cut content back into the input area later in the chat or that the first participant will perform another cut operation of entered content, thereby overwriting the first cut content stored in the clipboard. In addition, the process of cutting and pasting is prone to error, given the ease with which a user may err in selecting text, often resulting in the loss of information during the select/cut/select/paste editing cycle.

Another deficiency in current IM systems is that the ability to enter content is generally restricted to an active IM chat session. That is, a user is not able to enter content for future use in the IM system itself, saving that content until an IM chat session is started with the intended recipient. In addition, some IM systems do not permit a user to enter content at all if his/her status is set to “Do Not Disturb,” “Unavailable,” or some other restricted status.

Accordingly, there exists a need in the art to overcome the deficiencies and limitations described hereinabove.

### SUMMARY OF THE INVENTION

The invention provides a method, system, and program product for staging content for an instant messaging (IM) chat session. As used herein, “staging” means moving information in stages.

A first aspect of the invention provides a method of staging content for an instant messaging (IM) chat session, the method comprising: entering content into a staging area; and transferring the entered content from the staging area to at least one of the following: an input area or a transcript area.

A second aspect of the invention provides a system for staging content for an instant messaging (IM) chat session, the system comprising: a system for entering content into a staging area; and a system for transferring the entered content from the staging area to at least one of the following: an input area and a transcript area.

A third aspect of the invention provides a program product stored on a computer-readable medium, which when executed, stages content for an instant messaging (IM) chat session, the program product comprising: program code for entering content into a staging area; and program code for transferring the entered content from the staging area to at least one of the following: an input area and a transcript area.

A fourth aspect of the invention provides a method for deploying an application for staging content for an instant messaging (IM) chat session, comprising: providing a computer infrastructure being operable to: enter content into a staging area; and transfer the entered content from the staging area to at least one of the following: an input area and a transcript area.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-3 show illustrative instant messaging (IM) windows according to various embodiments of the invention;

FIG. 4 shows an illustrative buddy list according to another embodiment of the invention;

FIG. 5 shows a flow diagram of an illustrative method according to the invention; and

FIG. 6 shows a block diagram of an illustrative system according to the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

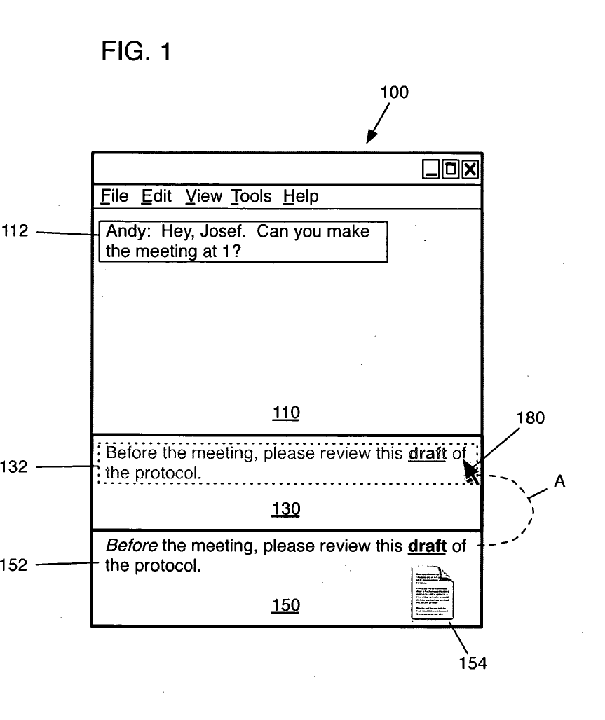

Turning now to the drawings, FIG. 1 shows an instant messaging (IM) chat window 100 having a transcript area 110, an input area 130, and a staging area 150. A user may enter content within the staging area 150 for use in the current chat session or a future chat session. In FIG. 1, the staging area 150 contains both a text entry 152 and a file 154. Applicants note that the types of content entered in the staging area 150 include those supported by the particular IM system being used. Such types of content may include, for example, text, application files, sound files, video, etc. In addition, if the IM system being used supports the use of formatted text, any text entered in the staging area 150 may be formatted there, as shown in the text entry 152.

In any case, content entered in the staging area 150 may be transferred (A) from the staging area 150 to the input area 130. Such transfer may be by any suitable method or mechanism, including, for example, copying and pasting, cutting and pasting, dragging and dropping, etc. For example, as shown in FIG. 1, the text entry 152 is being dragged and dropped from the staging area 150 to the input area 130 using a mouse arrow 180.

It should be noted that some or all content may first be entered into the input area 130 and then moved to the staging area 150 before ultimately being added to the transcript area 110. This may be useful, for example, where a user has entered content into the input area 130 during an IM chat session but, before adding it to the transcript area 150, wishes to review and/or modify the content further without disrupting the flow of the IM chat session.

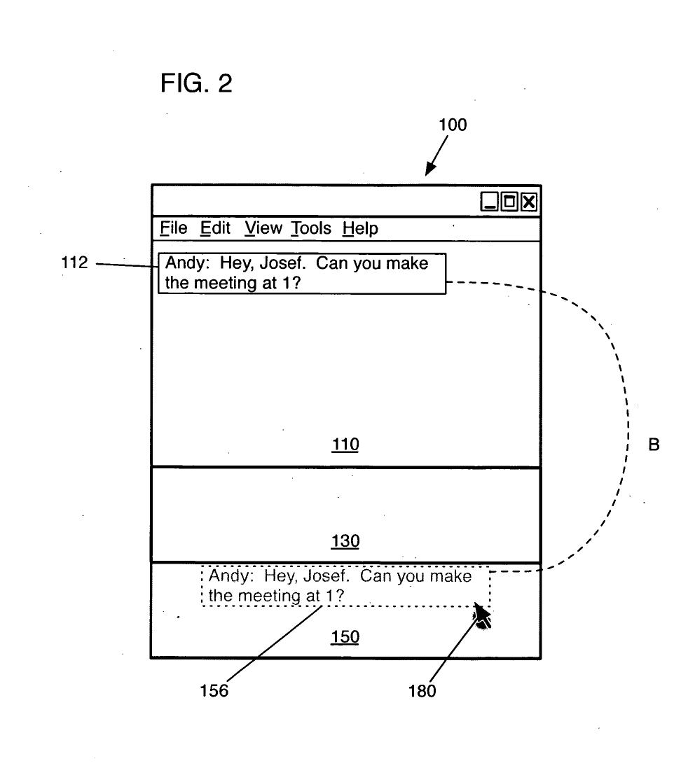

In FIG. 2, content (specifically, text entry 156) is being entered into the staging area 150 by dragging (B) a selected message 112 from the transcript area 110. A user may choose to do so, for example, if the message 112 is extensive and/or complex and the user wishes to amend or otherwise modify the contents of the message before adding it to the chat session him/herself. For example, a user may wish to amend the contents of a message from one user and then send the amended contents as a separate message to another user who is a participant in the current chat session or a different chat session.

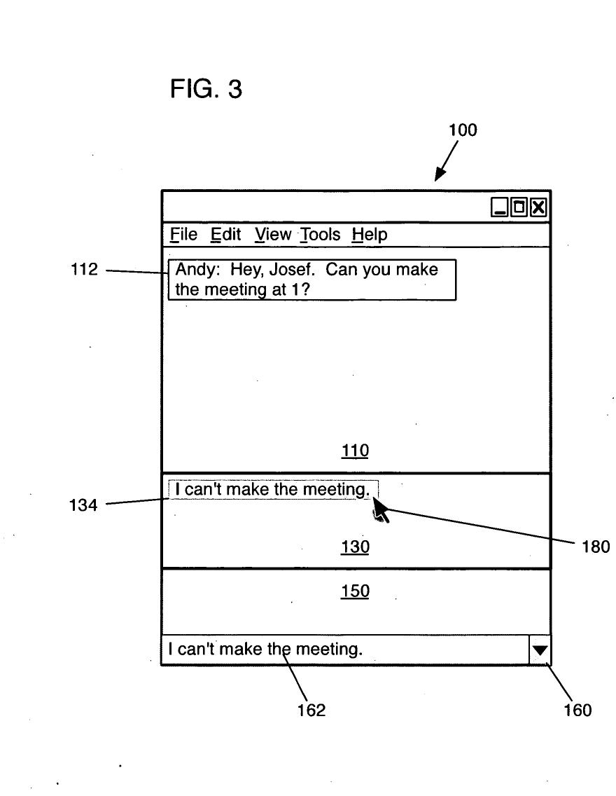

FIG. 3 shows yet another aspect of the invention, wherein content entered in the transcript area 110 or input area 130 (here, text entry 134 in the input area 130) is added to a pull-down menu 160 or similar menu within the staging area 150. The selected content may be either cut or copied from the transcript area 110 or input area 130 and pasted into the pull-down menu 160 or similar menu as a pull-down entry 162. This may be advantageous, for example, where a user intends to send the same or very similar content to a number of recipients within the same chat session or different chat sessions and wants to be able to easily access previously-entered content in the staging area 150. Accordingly, content within the pull-down menu 160 may be set for one-time use (i.e., once selected and transferred to the input area 130, the content is removed from the pull-down menu 160) or recurring use (i.e., the content persists within the pull-down menu 160 after being selected and transferred to the input area 130), whichever best serves the user's need.

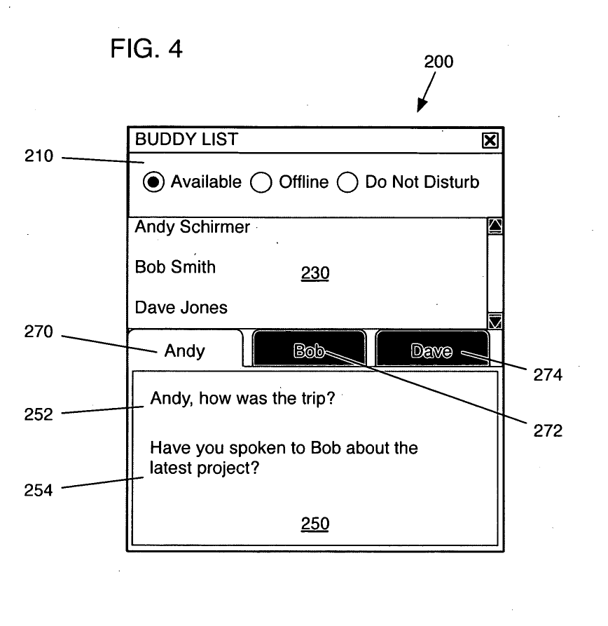

FIG. 4 shows a buddy list 200, a tool common to many IM systems, wherein the IM address or other contact information for potential chat participants is stored. Buddy list 200 includes a buddy area 230 and a staging area 250. As shown in FIG. 4, the buddy list 200 may also contain a status area 210, where a user can select his/her online availability for display to other potential chat participants.

Here, a plurality of tabbed staging areas is provided, each staging area being specific to a different buddy. A user may, therefore, choose a buddy tab 270, 272, 274 and enter content, such as text entries 252, 254, into the staging area 250 corresponding to the chosen buddy tab. Thus, a user may enter content specific to a particular buddy for use in a future chat session. Alternatively or in addition, a single staging area may be provided wherein entered content is available for use in a future chat session with any buddy included in the buddy list or with any other chat participant.

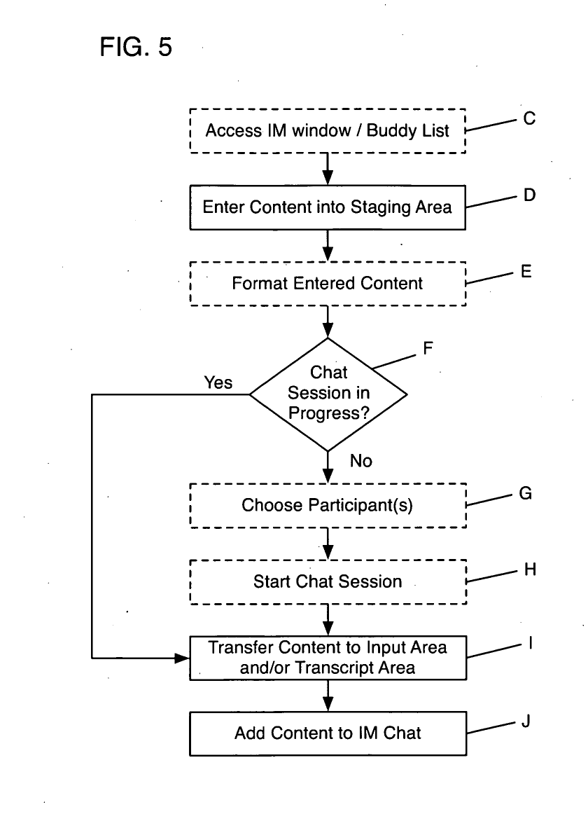

FIG. 5 shows a flow diagram of an illustrative method according to the invention. At C, if an IM chat session is not already in progress, a user accesses an IM window 100 (FIGS. 1-3) or a buddy list 200 (FIG. 4). At D, the user enters content into a staging area of the IM window or buddy list. At E, a user may optionally format all or a portion of the entered content.

At F, if an IM chat session is not already in progress (i.e., No at F), a user may choose one or more participants at G and start a chat session with those participants at H. If, on the other hand, the user is already engaged in a chat session (i.e., Yes at F), the user may proceed directly to transferring the content from the staging area to the input area and/or transcript area at I. At J, the user adds the content to the IM chat session. It should be recognized, of course, that the steps shown in FIG. 5 may take place in a different order or simultaneously. For example, in some IM systems, adding content to an IM chat by entering it into a transcript area may automatically start a chat session with the chosen participant(s) if such a chat session was not already in progress.

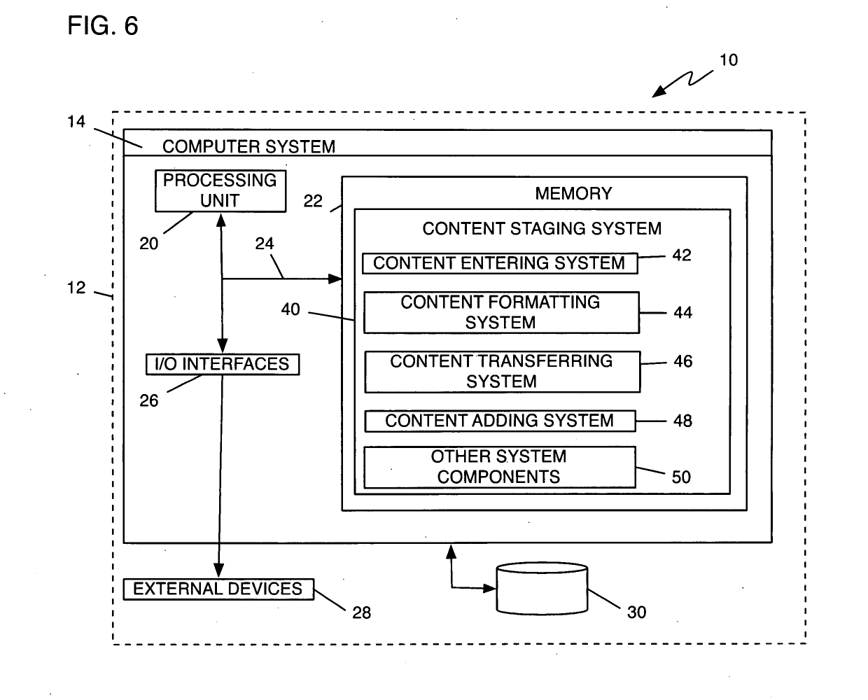

FIG. 6 shows an illustrative system 10 for staging content for an IM chat session. To this extent, system 10 includes a computer infrastructure 12 that can perform the various process steps described herein for staging content for an IM chat session. In particular, computer infrastructure 12 is shown including a computer system 14 that comprises a content staging system 40, which enables computer system 14 to stage content for an IM chat session by performing the process steps of the invention.

Computer system 14 is shown including a processing unit 20, a memory 22, input/output (I/O) interfaces 26, and a bus 24. Further, computer system 14 is shown in communication with external devices 28 and a storage system 30. As is known in the art, in general, processing unit 20 executes computer program code, such as content staging system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and content staging system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, content staging system 40 enables computer system 14 to stage content for an IM chat session. To this extent, content staging system 40 is shown including a content entering system 42, a content formatting system 44, a content transferring system 46, and a content adding system 48. Operation of each of these systems is discussed above. Content staging system 40 may further include other system components 50 to provide additional or improved functionality to content staging system 40. It is understood that some of the various systems shown in FIG. 6 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for staging content for an IM chat session, it is understood that the invention further provides various alternative embodiments. For example, in one embodiment, the invention provides a computer-readable medium that includes computer program code to enable a computer infrastructure to stage content for an IM chat session. To this extent, the computer-readable medium includes program code, such as content staging system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to stage content for an IM chat session, as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for staging content for an IM chat session. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of staging content for an instant messaging (IM) chat session, the method comprising:
entering content into a staging area;
transferring the entered content from the staging area to at least one of the following: an input area or a transcript area.

2. The method of claim 1, further comprising:
accessing an IM window having a transcript area, an input area, and a staging area.

3. The method of claim 2, wherein entering includes at least one action selected from a group consisting of: copying content from the transcript area, copying content from the input area, copying content from an external application, and inputting content using an input device.

4. The method of claim 1, further comprising:
accessing a window containing:
a list of potential IM chat participants; and
at least one staging area; and
initiating an IM chat session with at least one of the potential IM chat participants.

5. The method of claim 4, wherein initiating includes opening an IM window comprising a transcript area and an input area.

6. The method of claim 4, wherein the window includes a staging area for each of a plurality of potential IM chat participants.

7. The method of claim 1, further comprising:
formatting at least a portion of the entered content.

8. A system for staging content for an instant messaging (IM) chat session, the system comprising:
a system for entering content into a staging area;
a system for transferring the entered content from the staging area to at least one of the following: an input area or a transcript area.

9. The system of claim 8, further comprising:
a system for accessing an IM window having a transcript area, an input area, and a staging area.

10. The system of claim 8, further comprising:
a system for accessing a window containing:
a list of potential IM chat participants; and
at least one staging area; and
a system for initiating an IM chat with at least one of the potential IM chat participants.

11. The system of claim 10, wherein the system for initiating includes a system for opening an IM window comprising a transcript area and an input area.

12. The system of claim 10, wherein the window includes a staging area for each of a plurality of potential IM chat participants.

13. The system of claim 8, further comprising:
a system for formatting at least a portion of the entered content.

14. A program product stored on a computer-readable medium, which when executed, stages content for an instant messaging (IM) chat session, the program product comprising:
program code for entering content into a staging area; and
program code for transferring the entered content from the staging area to at least one of the following: an input area or a transcript area.

15. The program product of claim 14, further comprising:
program code for adding the entered content to an IM chat session

16. The program product of claim 14, further comprising:
program code for accessing an IM window having a transcript area, an input area, and a staging area.

17. The program product of claim 14, further comprising:
program code for accessing a window containing:
a list of potential IM chat participants; and
at least one staging area; and
program code for initiating an IM chat session with at least one of the potential IM chat participants.

18. The program product of claim 17, further comprising:
program code for opening an IM window comprising a transcript area and an input area.

19. The program product of claim 17, wherein the window includes a staging area for each of a plurality of potential IM chat participants.

20. The program product of claim 14, further comprising:
program code for formatting at least a portion of the entered content.

21. A method for deploying an application for staging content for an instant messaging (IM) chat session, comprising:
providing a computer infrastructure being operable to:
enter content into a staging area;
transfer the entered content from the staging area to at least one of the following: an input area or a transcript area.
